(19) United States
(12) Patent Application Publication
(10) Pub. No.: US 2006/0250464 A1
(43) Pub. Date: Nov. 9, 2006

(54) Method and apparatus for printing selected information on bottles

(76) Inventor: Yehoshua Sheinman, RaAnana (IL)

Correspondence Address: Martin D Moynihan;Prtsi Inc, PO Box 16446, Arlington, VA, 22215, US

(21) Appl. No.: 10/572,265

(22) PCT Filed:
(86) PCT No.: PCT/IL04/00838

Related U.S. Application Data
(60) Provisional application No. 60/503,452, filed on Sep. 17, 2003.

(51) Int. Cl. B41J 2/01

(52) U.S. Cl. 347/101

(57) ABSTRACT

A method and apparatus for printing selected information on bottles, by: conveying the bottles sequentially through a predetermined path including at least one printing station; actuating an ink-jet print head at the printing station to discharge liquid ink droplets onto the bottle in the printing station; and controlling the print head at the printing station to discharge the liquid ink droplets onto the bottle in accordance with the selected information to be printed thereon. Described, for purposes of example, are a closed-loop type conveyor and also a drum-type conveyor.

### FIELD AND BACKGROUND OF THE INVENTION

The present invention relates to a method and apparatus for printing selected information on bottles. The invention is particularly useful for printing labels or other selected information on bottles of relatively small size, such as used for containing medicines. The invention is therefore described below with respect to such application, but it will be appreciated that the invention could also be advantageously used for printing on or labeling other types of bottles, containers and the like.

Bottles generally require labeling with some type of printed information in order to indicate the bottle contents, health care information, bar codes, expiration dates, and the like. Such information is frequently printed directly on the bottles by using a screen-printing process, but such processes are not adaptable for frequent changes in the information to be printed because a separate screen is generally required to be prepared for each change. Another technique used for printing on bottles is to first print the desired information on a separate sheet, and then apply the sheet to the bottle, but such a technique is costly because of the need to first print the desired information on a separate sheet, and then to apply the sheet to the bottle.

### OBJECTS AND BRIEF SUMMARY OF THE PRESENT INVENTION

An object of the present invention is to provide a method and apparatus for printing on bottles having advantages in one or more of the above respects.

According to one aspect of the present invention, there is provided a method of printing selected information on bottles, comprising: conveying the bottles sequentially through a predetermined path including at least one printing station; actuating an ink-jet print head at the printing station to discharge liquid ink droplets onto the bottle in the printing station; and controlling the print head at the printing station to discharge the liquid ink droplets onto the bottle in accordance with the selected information to be printed thereon.

According to further features in the described preferred embodiments, relative movement is effected between the print head and the bottle in the printing station in accordance with the selected information to be printed on the bottle. In the described preferred embodiments, the relative movement is effected by rotating the bottle in the printing station relative to the print head, and also by linearly moving the print head relative to the bottle.

According to further features in the described preferred embodiments, the predetermined path through which the bottles are sequentially conveyed further includes a preliminary coating station having a preliminary coating head for applying a background coating to the bottle before conveyed to the printing station, and a final coating station having a final coating head for applying a protective transparent coating to the bottle over the printing applied in the printing station.

According to further features in the described preferred embodiments, the predetermined path through which the bottles are sequentially conveyed further includes a fixing station following each of the coating stations and the printing station for fixing the coating or ink applied in the respective station to the bottle by curing, heating or drying.

According to another aspect of the present invention, there is provided apparatus for directly printing selected information on bottles, comprising: a conveyor for conveying bottles through a predetermined path, the conveyor including an entry end at one end of the predetermined path, an exit end at the opposite end of the predetermined path, and at least one printing station between the entry end and the exit end; a feeder at the entry end of the conveyor for sequentially feeding to the conveyor bottles to be printed with selected information; a collector at the exit end of the conveyor for collecting bottles exiting from the conveyor after having been conveyed through the predetermined path; an ink-jet print-head in the printing station oriented to discharge liquid ink droplets directly onto a bottle on the conveyor when located on the printing station; and a control system for controlling the print head to discharge the liquid ink droplets onto the bottle in accordance with the selected information to be printed thereon.

In one embodiment described below for purposes of example, the conveyor includes: a pair of closed loops in parallel spaced relation to each other; a plurality of bottle carriers coupled to and extending between the closed loops; and an intermittently-operated drive for intermittently rotating the pair of closed loops.

In a second described preferred embodiment, the conveyor includes: a drum adapted to carry the bottles on its outer surface; and an intermittently-operated drive for intermittently rotating the drum.

As will be more particularly described below, such a method and apparatus provide a number of important advantages over the existing techniques briefly referred to above. Thus, the novel method and apparatus obviate the need for first printing the information onto a separate sheet, and then applying the sheet to the bottles, thereby reducing the overall costs. In addition, the novel method and apparatus lend themselves to quick and frequent changes in the type of information to be printed on the bottle, since such changes can be easily introduced as input data into the control system as and when desired.

Further features and advantages of the invention will be apparent from the description below.

### BRIEF DESCRIPTION OF THE DRAWINGS

The invention is herein described, by way of example only, with reference to the accompanying drawings, wherein:

FIG. 1 is a schematical view illustrating one form of apparatus constructed in accordance with the present invention;

FIG. 2 illustrates an implementation of the apparatus of FIG. 1;

FIG. 3 illustrates the conveyor in the apparatus of FIG. 2;

FIG. 4 illustrates the main components of each bottle carrier in the apparatus of FIG. 2;

FIG. 5 illustrates the mechanism for selectively coupling a bottle in the printing station or one of the coating stations to a rotary bottle drive in order to rotate the bottle during the printing thereon or coating thereof;

FIGS. 6 and 7 are three-dimensional and side-elevation views, respectively, illustrating a printing station containing a print head for printing on the bottles;

FIGS. 8 and 9 are corresponding views illustrating a coating station for applying a preliminary and/or final coating on the bottles;

FIG. 10 illustrates a drying station in the apparatus of FIG. 2;

FIG. 11 illustrates a modification in the apparatus wherein a drying station is incorporated in a printing or coating station;

FIG. 12 is a block diagram illustrating the overall control system in the apparatus of FIG. 2;

FIG. 13 illustrates a second form of apparatus constructed in accordance with the present invention, wherein the conveyor is in the form of a rotary drum;

FIG. 14 is a diagram illustrating the various operations performed at the various stations of the drum of FIG. 13;

FIG. 15 is a flow chart illustrating the operation of the drum-type printer of FIG. 13; and

FIG. 16 illustrates one manner of assembling a plurality of drum conveyors, each as illustrated in FIG. 13, for operation by a common drive and control system in order to multiply the output of the apparatus.

It is to be understood that the foregoing drawings, and the description below, are provided primarily for purposes of facilitating understanding the conceptual aspects of the invention and various possible embodiments thereof, including what is presently considered to be a preferred embodiment. In the interest of clarity and brevity, no attempt is made to provide more details than necessary to enable one skilled in the art, using routine skill and design, to understand and practice the described invention. It is to be further understood that the embodiments described are for purposes of example only, and that the invention is capable of being embodied in other forms and applications than described herein.

### DESCRIPTION OF PREFERRED EMBODIMENTS

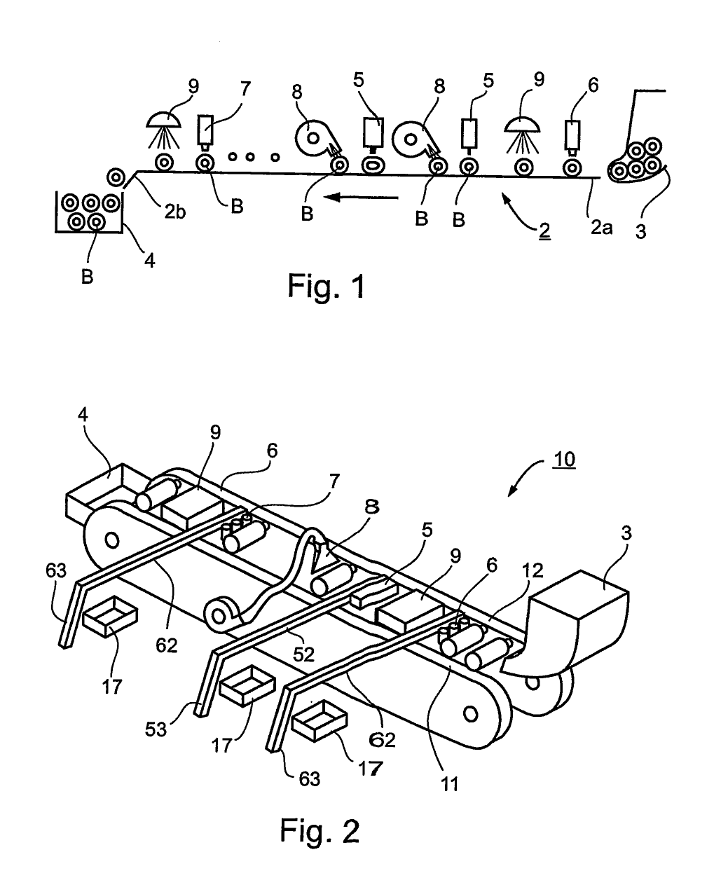

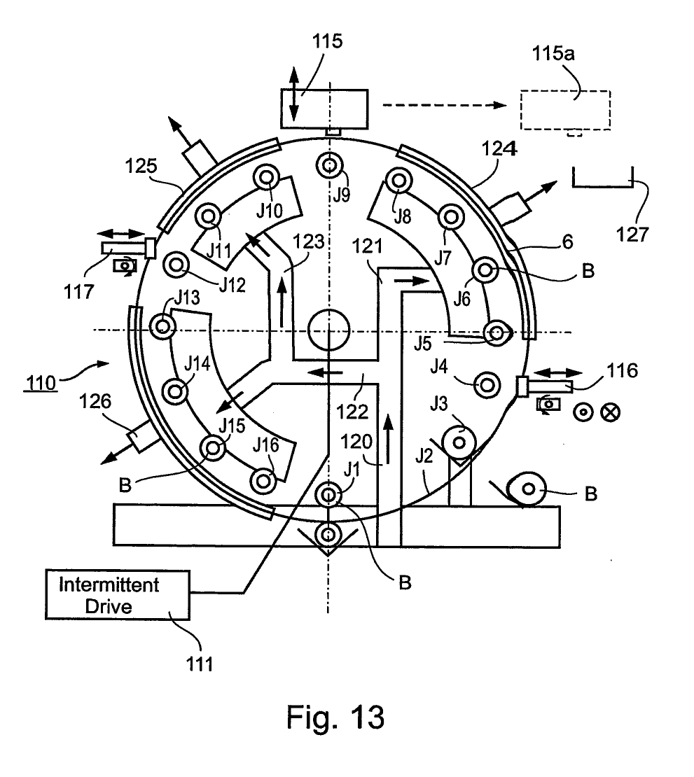

The invention is described below, for purposes of example, with respect to two types of apparatus for directly printing selected information on bottles. FIGS. 1-12 illustrate the invention implemented in a conveyor of the close-loop belt or cable type; whereas FIGS. 13-16 illustrate the invention implemented in a conveyor of the drum type.

### The Embodiment of FIGS. 1-12

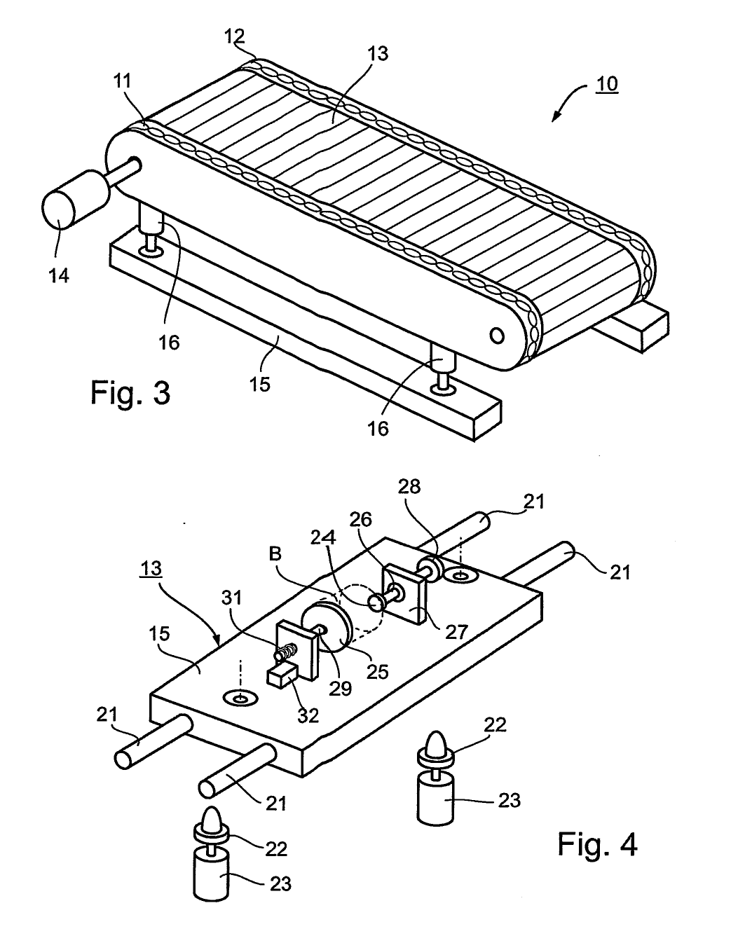

FIG. 1 schematically illustrates the basic components of this embodiment of the invention for directly printing selected information on bottles, whereas FIGS. 2 and 3 more particularly illustrate the conveyor used in this embodiment of the invention.

Thus, this embodiment of the invention includes a conveyor for conveying bottles through a predetermined path 2 having an entry end 2a communicating with a bottle feeder 3 for receiving the bottles B to be printed, and an exit end 2b communicating with a collector 4 for receiving the bottles after having been printed with the desired information. Between the entry end 2a and exit end 2b, the predetermined path 2 includes at least one printing station, preferably a plurality of printing stations for printing in color as will be described more particularly below, as well as a number of other processing stations for performing other operations on the bottle as it passes through the predetermined path from the entry end to the exit end.

Thus, as shown in FIG. 1, the processing stations between the entry end 2a and exit end 2b of predetermined path 2 include: a plurality of printing stations (two being shown) each occupied by a print head 5 for printing on the bottle B passing thereunder in a predetermined color; a preliminary coating station occupied by a coating head 6 immediately downstream of the entry end 2a of the predetermined path for applying a continuous background coating to each bottle to be printed by print heads 5; and a final coating station occupied by a coating head 7 immediately upstream of the exit end 2b of predetermined path 2 for applying a continuous, transparent, protective coating to each bottle after having been printed thereon by the print heads S.

The print heads 5 are ink-jet print heads oriented to discharge liquid ink droplets directly onto a bottle on the conveyer when located in the respective printing station. Any conventional ink-jet print heads may be used for this purpose, for example those described in our prior U.S. Pat. Nos. 5,969,733, 6,003,980 and 6,106,107, or in our International Patent Application PCT/IL02/00346, International Publication No. WO 02/090119, published Nov. 14, 2002, the contents of which U.S. patents and International Patent Application are incorporated herein by reference. In this case, the print heads would be controlled so as to discharge the liquid ink droplets onto the bottles B in accordance with the selected information to be printed thereon, as win be described more particularly below.

Coating head 6 at the preliminary coating station may be an “airbrush” of known construction for applying a continuous background coating to the bottle before being printed thereon by the print heads 5. The preliminary coating may be a white ink, e.g., of a standard low viscosity solvent-based ink or ultra violet (UV) curable ink. Since this coating is not changeable according to the data to be printed on the respective bottle, it may also be applied via a silk screen or other conventional process. Similarly, coating head 7 at the final coating station, which applies a continuous, transparent protective coating to each bottle after having been printed thereon, may also be an “airbrush” or screen since this coating is also not changeable according to the data to be printed on the bottle.

Each of the print heads 5 and coating head 6, 7, is followed by a fixing device for fixing the respective printing or coating by curing, heating or drying. Thus, as shown in FIG. 1, each of the print heads 5 is followed by a blower 8 for fixing the printed data by drying; and each of the coating heads 6, 7 is followed by a heater or radiation source 9 to fix the coating by curing or heating. If liquid material applied in the respective printing or coating station is of a solvent-based ink or coating, each of the fixing heads would be a heater or blower; whereas if the applied ink or coating is of a heat-curable material, the respective fixing head would be a heater or radiation source which fixes the respective ink or coating by curing.

The schematical view of FIG. 1 does not illustrate the device for applying the bottles B from feeder 3 to the conveyor at the entry end 2a, or the device for removing the printed bottles from the conveyor at the exit end 2b, as conventional devices may be used for this purpose.

FIGS. 2 and 3 more particularly illustrate the conveyor, generally designated 10, defining the predetermined path 2 through which the bottles are conveyed for processing in the above-described manner. Thus, as shown particularly in FIG. 3, conveyor 10 includes a pair of closed loops 11, 12 of belts or chains in parallel spaced relation to each other; a plurality of bottle carriers 13 coupled to and extending between the closed loops; and an intermittently-operated drive 14 for intermittently rotating the pair of closed loops. The upper stretch of the pair of closed loops 11, 12, together with the bottle carriers 13 coupled and extending between them, defines the predetermined path 2 of the conveyor through which the bottles are conveyed for processing as described above with respect to FIG. 1; whereas the lower stretch of the pair of closed loops defines the return path for the conveyor.

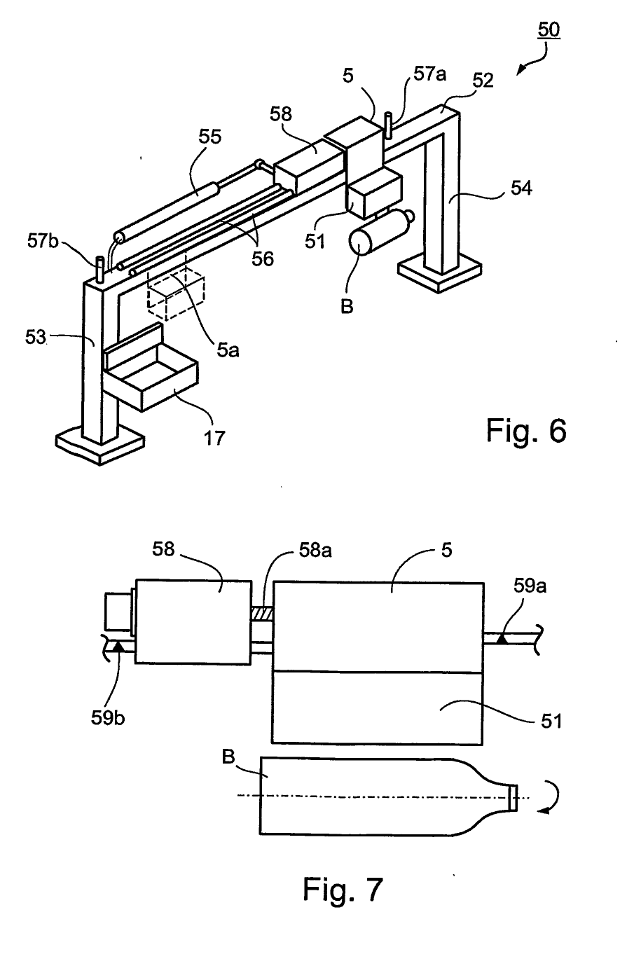

As particularly shown in FIG. 3, the conveyor 10 is adjustably mounted on a supporting base 15 by a plurality of mounting members 16 which are vertically adjustable in order to accommodate different diameters of bottles B by raising or lowering the upper stretch of the conveyor belts with respect to the printing, coating, and fixing heads mounted thereover. As shown in FIG. 2, a sink 17 is provided under each of the print heads 5 and coating heads 6 and 7 to receive any discharges of ink or coating material from the respective head when the head is in a non-printing or non-coating position, as will be described more particularly below with respect to FIGS. 6-9.

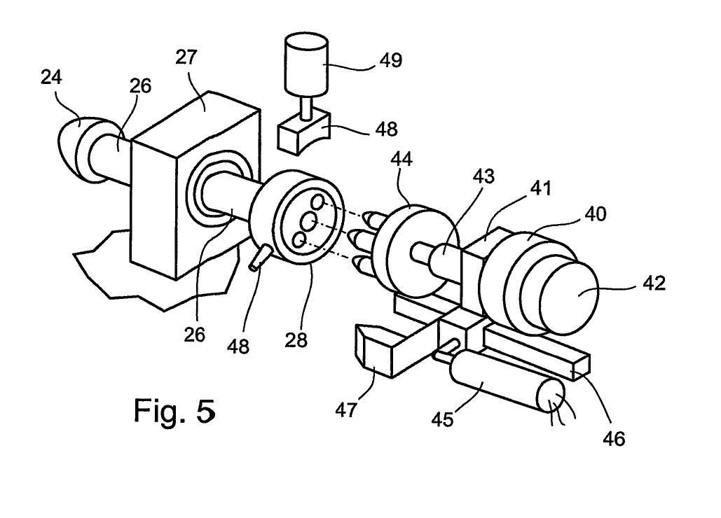

As will also be more particularly described below, the operation of the intermittent drive 14 causes each bottle B to be sequentially conveyed from one station to the next for processing in the respective station. When the bottle is in one of the printing stations occupied by a print head 5, or in a coating station occupied by coating head 6 or 7, the bottle is rotated in the respective station so as to expose a predetermined area of its entire circumferential surface to the respective head. FIG. 4 illustrates the structure of each bottle carrier 13 permitting the bottle thereon to be rotated in the respective station, whereas FIG. 5 illustrates the mechanism for rotating the bottle in the respective station.

Thus, as shown in FIG. 4, each bottle carrier 13 is a flat base or panel mounted between the closed loops 11, 12 by a pair of links 21. At least one station includes a pair of stops 22, each actuatable by an actuator 23 such as a pneumatic device, to engage a link 21 on the opposite sides of the bottle carrier 13, and thereby to precisely define the proper position of the bottle carrier in the respective station.

As further seen in FIG. 4, each bottle carrier 13 on conveyor 10 includes a pair of heads 24, 25 engageable with the opposite ends of the bottle to be carried by the respective carrier for clamping the bottle to the carrier. Head 24 is coupled by a shaft 26, passing through a mounting plate 27, to a coupling member 28 of a rotary bottle drive, as described more particularly below with respect to FIG. 5; whereas head 25 is rotatable mounted on another shaft 29 passing through a mounting plate 30 and spring urged by spring 31 into engagement with the opposite end of the bottle B carried by carrier 13. Shaft 29 is fixed to mounting plate 30, and the mounting plate is adjustable along a rail 32 in order to accommodate bottles of different sizes.

FIG. 5 illustrates the rotary bottle drive 40 which rotates the bottle B in a printing or coating station with respect to the print head or coating head in the respective station. As shown in FIG. 5, the rotary bottle drive 40 is an electrical motor mounted on a base 41 fixed with respect to the conveyor so as to be in alignment with a bottle carried by carrier 13 when in one of the printing or coating stations and to rotate, via head 24, the bottle in the respective station with respect to the printing or coating head therein. Rotary drive 40 is preferably a step-type electrical motor and includes a rotary encoder 42 to track the rotary movements of the motor. Motor 40 rotates, via shaft 43, a male coupling member 44 which is selectively engageable with female coupling member 28 coupled, via shaft 26, to drive head 24 which rotates the bottle on the respective carrier 13. Engagement and disengagement of male coupling member 44 with female coupling member 28 is effected by a linear drive 45, preferably a pneumatic piston, which displaces motor 40 and its male coupling member 43 towards or away from female coupling member 28 as guided by a linear guide 46.

Motor base 41 further includes a position sensor 47 cooperable with a flag 48 carried by female coupling member 28, to sensor the actual position of the female coupling member 28, and thereby of the bottle on the carrier in the respective station. For example, position sensor 47 may be an LED sensor, whereas flag 48 may be a pin projecting from the outer surface of the female coupling member 28.

When coupling member 28 is disengaged from coupling member 44 of rotary drive 40, coupling member 28, and thereby the bottle B coupled thereto, is held in position by a brake 48 actuated by an actuator 49, such as a pneumatic piston.

FIGS. 6 and 7 illustrate a printing station, generally designated 50, occupied by one of the print heads 5 for directly printing selected information on the bottle when in that station. Thus, print head 5 includes a line of ink discharge nozzles, generally designated 51, mounted by a horizontal beam 52 to overlie the bottle B in the printing station. Horizontal beam 52 is supported by a pair of vertical uprights 53, 54 which may be vertically adjustable so as to accommodate different size bottles. Print head 5 may be moved by an actuator 55, e.g., a pneumatic piston, to either its operative printing position, shown in full lines in FIG. 6 overlying bottle B, or to a non-operative position, shown in broken lines at 5a, to overlie an ink sink 17, to receive any ink discharges from the head when in its non-operative or non-printing position, e.g., for maintenance purposes. The linear movement of print head 5 to either of these positions is guided by a pair of guide rails 56. Mounting beam 52 includes a pair of end stops 57a, 57b to define the above two positions of the print head.

As indicated earlier, print head 5 is preferably an ink-jet print head, of any of the known constructions identified above, carrying a plurality of nozzles discharging liquid ink droplets directly onto the bottle in the printing station to print any desired information as controlled by the data inputted into the control system. Preferably, the nozzles 51 eject the drops continuously and deflect the drops according to the desired digital pattern, creating a drop fan or “beam” of a width of 0.5 to 1 mm. A typical distance between adjacent nozzles in the line is 8 mm. Therefore, the print head 5 is driven linearly in the longitudinal direction to move the nozzles over the bottle in synchronization with the rotation of the bottle.

For this purpose, the printing station 50 further includes a linear motor 58 coupled to head 5 via a screw 58a (FIG. 7) to displace the nozzles 51 longitudinally of the bottle B, and two end sensors 59a, 59b, for sensing the end of travel of the head during this printing operation. This linear movement of print head 5 relative to the bottle during the printing operation is synchronized with the bottle rotation (effected by rotary drive 40, FIG. 5), and with the print data supplied to print head 5, for printing the desired information at the desired location directly on the bottle B.

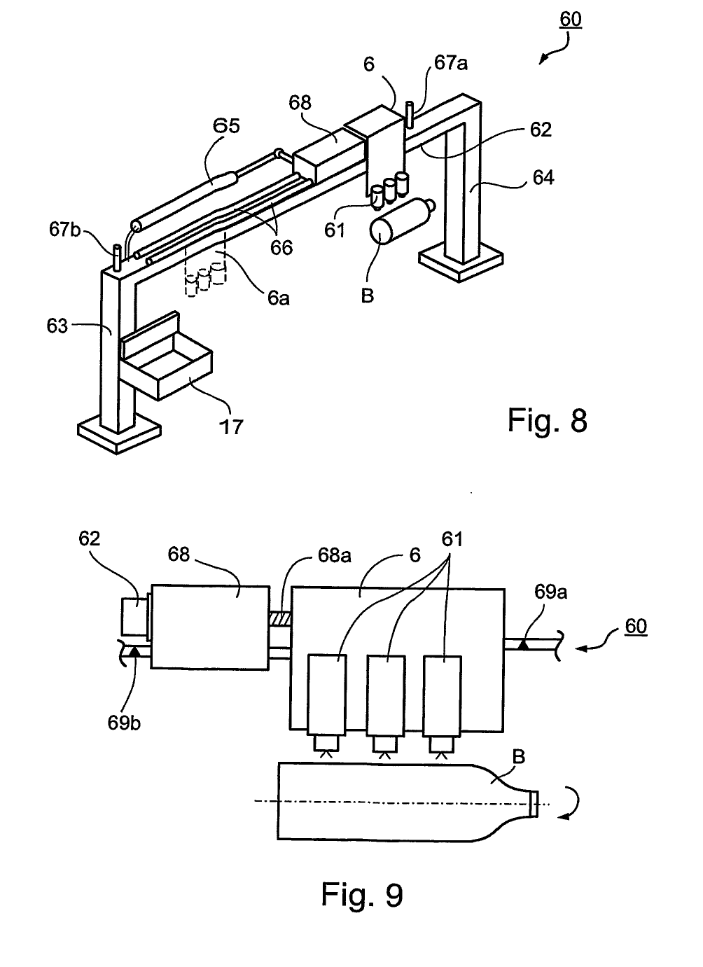

FIGS. 8 and 9 illustrate the coating station, generally designated 60, occupied by coating head 6 which applies the continuous background coating to the bottle before the bottle is printed thereon by the print heads 5. Coating station 60 is basically similar to printing station 50 described above, except that the coating head 60 carries a plurality of air-brush nozzles 61 (rather than ink-jet nozzles) which apply a continuous coating of atomized coating material to the bottle B.

Thus, as shown in FIGS. 8 and 9, coating head 6 is mounted on a horizontal beam 62 supported by a pair of uprights 63, 64 to overlie bottle B in the coating station. Uprights 63, 64 may be vertically adjustable in order to accommodate bottles of different diameters.

As described above with respect to printing station 50, coating station 60 also includes an actuator 65 for moving head 6 either to its operative coating position, shown in full lines in FIG. 8, overlying the bottle B, or to a non-operative, non-coating position, shown in broken lines at 6a, to overlie a sink 17. This linear movement of head 6 is guided by a pair of guide rails 66, and its two positions are defined by a pair of pins 67a, 67b carried by beam 62. Also, as in the printing station structure described above with respect to FIGS. 6 and 7, the coating head 6, during a coating operation, is displaced longitudinally of the bottle by a linear motor 68 driving a screw 68a (FIG. 9), and its end positions are sensed by two sensors 69a, 69b, respectively. Linear drive 68 for displacing the coating head 6, as well as linear drive 58 for displacing the print head 5 in the printing station, may be a step motor so as to enable the displacement of the coating head to be synchronized with the rotation of the bottle in order to produce a smooth, uniform background coating on the bottle.

The structure of the coating station 60 described above occupied by the preliminary coating head 6 may also be used for the coating station occupied by the final coating head 7 (FIG. 1) which applies the transparent protective film over the bottle after passing through the one or more printing stations.

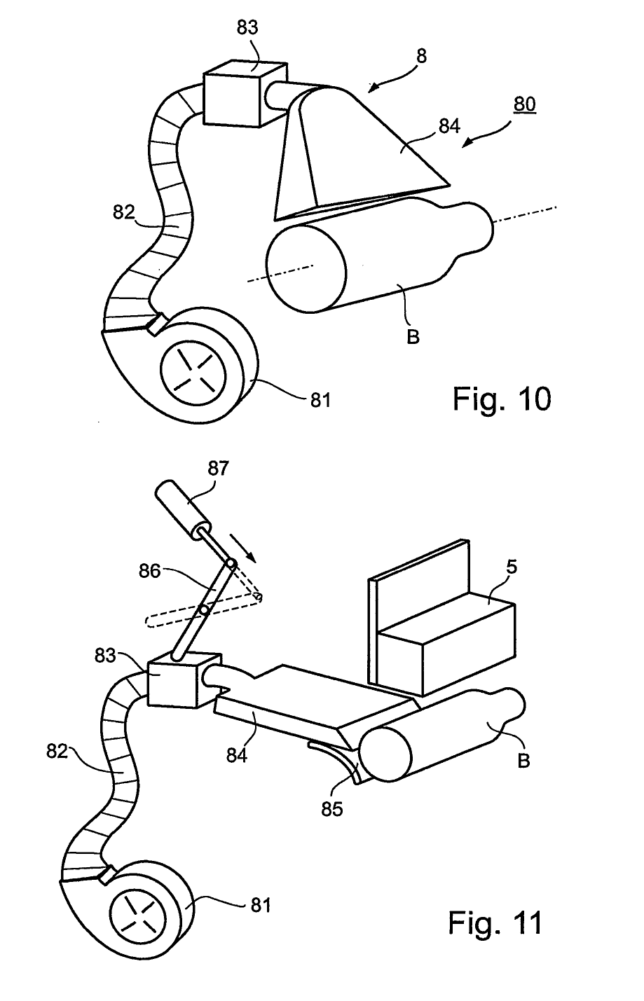

FIG. 10 illustrates the structure of a drying station, generally designated 80, occupied by one of the dryers 8 in FIG. 1 following each print head 5. Preferably, such a drying station is separate from the printing station itself in order to avoid the possibility of hot air flow produced in the drying station from affecting the flight of the ink drops from the print head in the printing station. Thus, as shown in FIG. 10 air blower 8 includes a blower motor 81 directing the air via a hose 82 through a heater 83 to a slitted air spreader 84 directly onto the ink applied to the bottle B. Because of long air temperature stabilization time, air blower 8 preferably operates continuously regardless of the existence of a bottle in that station.

FIG. 11 illustrates a modification wherein the drying station is part of the printing station. Thus, the station illustrated in FIG. 11 also includes the print head 5, together with the blower air spreader 84 supplied with heated air from blower 81 via conduit 82 and heater 83. In this case, since the drying station is combined with the printing station, the air spreader 84 is provided with a shield 85 to shield the printing region from air turbulences during the printing operation, and also with a lifting mechanism including links 86, 87 for diverting the spreader from the printing region during non-printing operations.

The heating devices 9 illustrated in FIG. 1 may be commercially available ultra violet lamps for curing or heating the coating materials applied by the preliminary coating head 6 and final coating head 7, respectively.

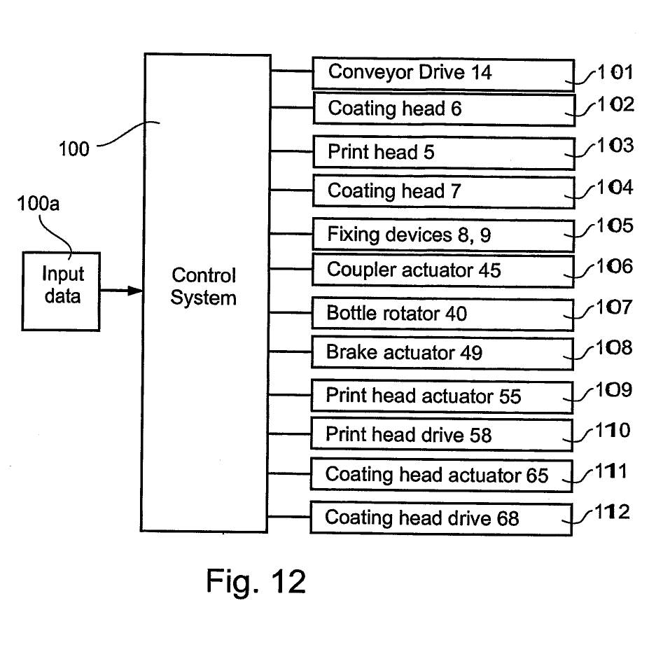

The overall operation of the apparatus will now be described with reference to the block diagram of the control system illustrated in FIG. 12.

Thus, the control system 100 receives input data 100a including the particular information to be printed on the bottles, and controls the various elements of the apparatus according to the inputted data. The bottles B to be processed are individually applied from feeder 3 at the entry end 2a of the conveyor line and are conveyed, in steps, past the various processing stations illustrated in FIG. 1 to the exit end 2b, where they are collected by collector 4. As a preliminary matter, the height of the conveyor may be adjusted by the vertical uprights 16 (FIG. 3) according to the diameter of the bottles being processed, and the mounting plates 30 on the bottle carriers 13 (FIG. 4) may similarly be adjusted according to the length of the bottles being processed.

Control system 100 controls conveyor drive 14 (FIG. 3) to advance each bottle carrier 13 in the upper stretch of the conveyor sequentially past each of the processing stations, as illustrated in FIG. 1 (box 101). The first such station is a coating station occupied by coating head 6, which applies a background coating to the bottle, fixed by curing, heating or drying in the immediately following station occupied by heater 9, under the control of control system 100 as indicated by boxes 102 and 105, FIG. 12.

The bottle is then conveyed to the first printing station occupied by the first print head 5 which, again under the control of the input data via control system 100, discharges liquid ink droplets directly onto the bottle (i.e., onto the coating applied by coating head 6), as indicated by block 103, FIG. 12, which coating is fixed by the subsequent fixing device 8 (block 105). If the printing is to be of a single color, only one printing station is needed; but if the printing is to be in a plurality of colors, the appropriate number of printing heads would be used. Finally, the bottle is conveyed to the final coating station 7 where the final protective coating is applied and fixed, as indicated by blocks 104 and 105 in FIG. 12.

In each of the printing stations 5 and coating stations 6, 7, the bottle is rotated in order to expose its complete circumferential surface to the respective head. Thus, when the bottle reaches such a station, linear drive 45 causes the male coupling member 44 of the bottle rotator 40 to engage female coupling member 28 fixed to the end of drive wheel 24 engaging one end of the bottle B (FIGS. 4, 5); then bottle rotator 40 is energized to rotate the bottle in the respective station. The foregoing are indicated by blocks 106 and 107 in FIG. 12. Rotary encoder 42 tracks the rotary movement of bottle rotator 40, and the home position of the bottle is indicated by pin 48 as sensed by sensor 47.

Whenever a bottle on a bottle carrier 13 is not coupled to the bottle rotator 40 as described above, the bottle is retained in its rotary position by brake 48, which brake is withdrawn by actuator 49 when the bottle is to be rotated, as indicated by block 108, FIG. 12.

In addition, during each of the printing and coating operations, the respective print head or coating head is driven linearly of the bottle, by printing head drive 58 (FIGS. 6, 7) and coating head drive 68 (FIGS. 8, 9), under the control of the control system 100, as indicated by blocks 110 and 112, respectively, FIG. 12. When the print heads 5 and/or coating heads 6, 7 are not to be operative, (e.g., for maintenance purposes) their respective actuators 55 and 65 move the heads from a printing or coating position overlying the bottle, to a non-operative position overlying one of the sinks 17, also under the control of control system 100 as indicted by blocks 109 and 111, respectively, in FIG. 12.

It will thus be seen that the apparatus described above with respect to FIGS. 1-12 is capable of directly printing selected information on bottles which information can be conveniently changed as desired.

### The Embodiment of FIGS. 13-16

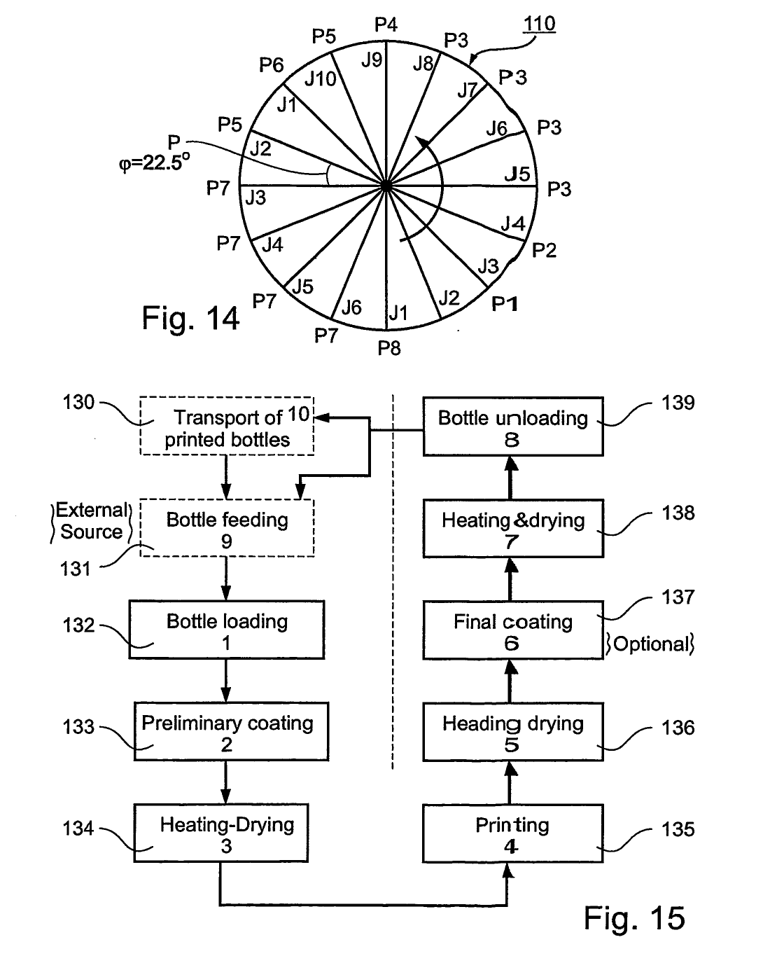

FIGS. 13-16 illustrate the invention embodied in a drum-type conveyor apparatus. Such an apparatus includes a drum, generally designated 110, adapted to carry the bottles B on its outer surface, and an intermittent drive 111 for driving the drum in stepped movements to convey each bottle sequentially through a plurality of processing stations extending around the outer surface of the drum. FIG. 14 diagrammatically illustrates, for purposes of example, drum 110 steppable through 16 positions during one complete rotation thereof, which positions are indicated as J₁-J₁₆, and eight processes, indicated as P₁-P₈, taking place in the 16 positions of the drum.

Thus, as shown in FIG. 13 position J₃ is the loading position of the drum, wherein the bottles are loaded (process P₁) on the outer circumference of the drum. The bottles may be loaded by any suitable loading mechanism and carried on the outer surface of the drum by the holder devices described above particularly with respect to FIGS. 4 and 5.

Position J₄ is the preliminary coating position wherein the preliminary coating is applied (process P₂) to serve as a continuous background coating. For this purpose, this position of the drum is occupied by a coating head 116, corresponding to coating head 6 in FIG. 1, for applying the preliminary continuous coating to the bottle. As indicated by the arrow, coating head 116 may be movable towards and away from the drum according to the size or shape of the bottle being coated.

The next four positions (J₅-J₈) are used for drying and/or heating (process P₃) the coating applied by coating head 116. For this purpose, the interior of drum 110 is supplied with a heating fluid, such as hot air, via channels 120, 121, 122, 123 for heating the bottle at that respective location of the drum. Thus, when the bottle is in any one of the four positions J₅-J₈ of the drum, it is heated by the hot air via channels 120, 121, which hot air is collected by hot air collection unit 124. To assure adequate drying of the coating material applied by coating head 116, four drum positions (J₅-J₈) are allocated to this heating and drying operation.

When the bottle reaches drum position J₉, it becomes aligned with the ink-jet print head 115 (FIG. 13), corresponding to print head 5 in the embodiment of FIGS. 1-12. While the bottle is in this position, the ink-jet print head discharges liquid ink droplets directly onto the bottle in accordance with the selected information to be printed thereon (process P₄). Preferably, print head 115 is adjustable towards and away from the drum, as indicated by the arrow, to accommodate the diameter of the bottle being processed. Since this printing process is relatively rapid, only one angular position of the drum (position J₉) is allocated for performing this printing operation.

The next two rotary positions of the drum (J₁₀, J₁₁) are allocated for drying and heating the ink applied by the print head 115 (process P₅). For this purpose, heated air is supplied, via channels 120, 122 and 123, to heat the bottle when in this position of the drum, which heated air is collected via hot air collection unit 125.

The bottle in the next rotary position of the drum (position J₁₂) is aligned with the final coating head 117, corresponding to coating head 7 in the embodiment of FIGS. 1-12, for applying a continuous transparent protective coating over the bottle (process P₆). Head 117 is also movable towards and away from the drum, as indicated by the arrow, to enable it to accommodate bottles of different diameters. This process is also relatively rapid, and therefore only one rotary position of the drum is allocated for performing this operation

The next four rotary positions of the drum (positions J₁₃-J₁₆) are allocated for drying and heating the coating material applied by coating head 117 (process P₇). For this purpose, hot air is conducted via channels 120, and 122 to the bottles occupying this position of the drum, and collected by air collection unit 126. When the bottles reach the first position J₁, an unloading operation is performed (process P₈) on the printed and coated bottle.

This embodiment of the invention also preferably includes a sink, indicated by sink 127, FIG. 13, for the print head 115 when moved to a lateral position, shown at 115a, for receiving any ink discharge from the respective head during the non-operating position of the head. A similar sink may be provided at each of the coating stations occupied by the coating head 116, 117.

FIG. 15 is an overall flow chart illustrating the operation of the apparatus of FIGS. 13 and 14. Thus, the bottles are transported to the drum in any convenient manner (block 130), fed to the drum by a bottle feeder (block 131) (from an external source), and loaded onto the drum in any convenient manner (block 132). In bottle position J₄, the preliminary coating is applied by coating head 116 (block 133), and this coating is heated and dried in drum positions J₅-J₈ (block 134). The information to be applied to the bottle is then printed on the bottle while in rotary position J₄ by printing head 115 (block 135), and this printing is then heated and dried in rotary positions J₁₀-J₁₁ (block 136). While the bottle is in rotary position J₁₂, the final coating is applied via coating head 117 (block 137), which coating is heated and dried in the drum rotary positions J₁₃-J₁₆. When the drum reaches its first rotary position (J₁), the printed and coated bottle is unloaded (block 139).

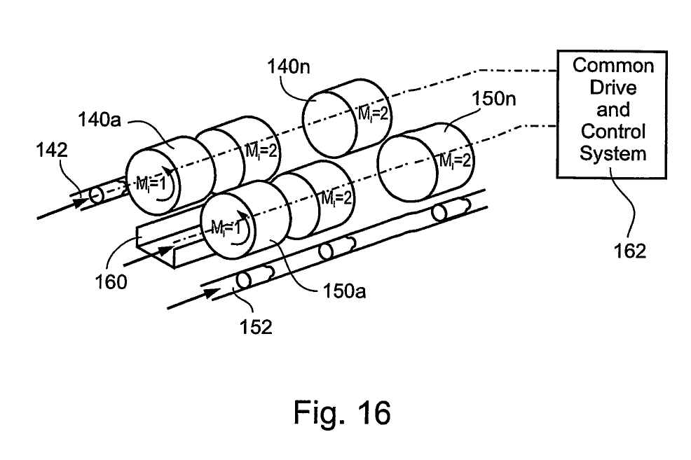

FIG. 16 illustrates a modular system including a plurality of conveyors of the drum type for multiplying the output of the printing apparatus. Thus, such a system includes one line of drum conveyors, shown at 140a-140n, and a second line of drum conveyors 150a-150n, each drum conveyor being of the type as described above with respect to FIGS. 13-15 for processing a plurality of bottles at the same time. One line of drum conveyors 140a-140n is fed by a feeder 142 extending along that line of conveyors for loading the bottles thereon, and the second line of conveyors 150a-150n is fed by a second feeder 152 extending along that line of conveyors for loading the bottles thereon. The two feeders are disposed along the outer sides of the two lines of conveyors. A common collector 160 is disposed between the two lines of conveyors for receiving the bottles therefrom after having being processed in the respective conveyors.

The two lines of conveyors 140a-140n and 150a-150n are coupled to a common intermittent drive, and are also controlled by a common control system, as indicated by box 162.

While the invention has been described with respect to several preferred embodiments, it will be appreciated that these are set forth for purposes of example only, and that many other variations and modifications may be made. For example, the invention could be implemented with other types of conveyors, and may use other bottle holding devices. Many other variations, modifications and applications of the invention will be apparent to those skilled in the art.

What is claimed is:

1. A method of printing selected information on bottles, comprising:
conveying the bottles sequentially through a predetermined path including at least one printing station;
actuating an ink-jet print head at said printing station to discharge liquid ink droplets onto the bottle in said printing station; and
controlling said print head at said printing station to discharge said liquid ink droplets onto said bottle in accordance with the selected information to be printed thereon.

2. The method according to claim 1, wherein relative movement is effected between said print head and the bottle in said printing station in accordance with the selected information to be printed on said bottle.

3. The method according to claim 2, wherein said relative movement includes rotating the bottle in said printing station relative to said print head.

4. The method according to claim 2, wherein said relative movement includes moving said print head linearly relative to said bottle.

5. The method according to claim 1, wherein said predetermined path through which the bottles are sequentially conveyed further includes a preliminary coating station having a preliminary coating head for applying a background coating to the bottle before conveyed to said printing station, and a final coating station having a final coating head for applying a protective transparent coating to the bottle over the printing applied in said printing station.

6. The method according to claim 5, wherein said bottle is rotated while in said preliminary coating station, printing station, and final coating station, relative to said preliminary coating head, printing head and final coating head, respectively.

7. The method according to claim 6, wherein said bottle rotation is effected by coupling each bottle, after conveyed to the respective station, to a bottle drive, and decoupling the bottle from said bottle drive before being conveyed out of the respective station.

8. The method according to claim 5, wherein said predetermined path through which the bottles are sequentially conveyed further includes a fixing station following each of the coating stations and the printing station for fixing the coating or ink applied in the respective station to the bottle by curing, heating or drying.

9. The method according to claim 1, wherein said bottles are sequentially conveyed through said predetermined path by a closed-loop belt-type conveyor.

10. The method according to claim 1, wherein said bottles are sequentially conveyed through said predetermined path by a drum-type conveyor.

11. Apparatus for directly printing selected information on bottles, comprising:
a conveyor for conveying bottles through a predetermined path, said conveyor including an entry end at one end of said predetermined path, an exit end at the opposite end of said predetermined path, and at least one printing station between said entry end and said exit end;
a feeder at said entry end of the conveyor for sequentially feeding to said conveyor bottles to be printed with selected information;
a collector at said exit end of the conveyor for collecting bottles exiting from said conveyor after having been conveyed through said predetermined path;
an ink-jet print-head in said printing station oriented to discharge liquid ink droplets directly onto a bottle on said conveyor when located in said printing station;
and a control system for controlling said print head to discharge said liquid ink droplets onto said bottle in accordance with the selected information to be printed thereon.

12. The apparatus according to claim 11, wherein said conveyor further includes:
an intermittent conveyer drive for intermittently driving said conveyor; and
a further drive for effecting relative movement between a bottle in said printing station and said print head while printing on the bottle.

13. The apparatus according to claim 12, wherein said further drive includes a rotary bottle drive located in alignment with a bottle when in said printing station and effective to rotate said bottle in the printing station.

14. The apparatus according to claim 13, wherein said conveyor further includes:
a pair of heads for each bottle engageable with the opposite ends of the bottle for clamping the bottle to the conveyor;
one of said heads being coupleable to said rotary bottle drive when the respective bottle is in said printing station to rotate the bottle therein;
the other of said heads being spring-urged towards said one head to clamp the bottle between the pair of heads.

15. The apparatus according to claim 14, wherein said other head is carried by a mounting member movable with respect to a guide rail towards said one head to accommodate bottles of different sizes.

16. The apparatus according to claim 14, wherein said one head is coupleable to said rotary bottle drive by a first coupling member carried by said one head, a second coupling member carried by said rotary bottle drive, and a linear drive for effecting the coupling of said first and second coupling members when the respective bottle is in said printing station.

17. The apparatus according to claim 14, wherein said conveyor further comprises a brake for each bottle, said brake being selectively engageable with said one head of the respective bottle for preventing rotation of the bottle when not coupled to said rotary bottle drive.

18. The apparatus according to claim 13, wherein said rotary bottle drive is a step motor and includes a rotary encoder.

19. The apparatus according to claim 11, wherein said apparatus further comprises:
an ink sink laterally of said printing station; and
a print head drive for selectively driving said print head, under the control of said control system either to a printing position in alignment with a bottle in said printing station for printing thereon, or to a non-printing position in alignment with said ink sink for receiving any liquid ink droplets discharged from said print head.

20. The apparatus according to claim 12, wherein said further drive includes a linear drive for linearly driving said print head relative to the bottle in said printing station.

21. The apparatus according to claim 11, wherein said predetermined path of the conveyor further includes, in addition to said at least one printing station, a preliminary coating station immediately downstream of said entry end for applying a continuous background coating to each bottle to be printed thereon, and a final coating station immediately upstream of said exit end for applying a continuous, transparent protective coating to each bottle after printing thereon.

22. The apparatus according to claim 11, wherein said predetermined path includes a plurality of said printing stations sequentially located along said predetermined path, each printing station including a print head controlled by said control system for discharging liquid ink of a predetermined color directly onto the bottles conveyed by said conveyor.

23. The apparatus according to claim 22, wherein each of said printing stations is followed by a fixing station for fixing the applied ink by curing, heating or drying.

24. The apparatus according to claim 11, wherein said conveyor includes:
a pair of closed loops in parallel spaced relation to each other;
a plurality of bottle carriers coupled to and extending between said closed loops; and
an intermittently-operated drive for intermittently rotating said pair of closed loops.

25. The apparatus according to claim 24, wherein said pair of closed loops include an upper stretch defining said predetermined path through which the bottles are conveyed, and a lower stretch defining a return path for the closed loops.

26. The apparatus according to claim 25, wherein said predetermined path defined by said upper stretch includes at least one printing station, a preliminary coating station upstream of said printing station for applying a continuous background coating to each bottle to be printed thereon, a final coating station downstream of said printing station for applying a continuous transparent protective coating to each bottle after printing thereon, and a fixing station following each of said coating and printing stations for fixing the coating or ink applied in the respective station by curing, drying or heating.

27. The apparatus according to claim 11, wherein said conveyor includes:
a drum adapted to carry said bottles on its outer surface; and
an intermittently-operated drive for intermittently rotating said drum.

28. The apparatus according to claim 27, wherein said print head faces the outer surface of said drum for printing on a bottle in said printing station; and wherein said apparatus further includes an initial coating head facing the outer surface of said drum for applying a continuous background coating to each bottle before being printed thereon, and a final coating head facing the outer surface of said drum for applying a continuous, transparent protective coating to each bottle after printing thereon.

29. The apparatus according to claim 28, wherein the interior of said drum includes heating channels for conducting a heating fluid to the inner surface of said drum at locations between said ink head and said coating heads to fix the ink or coating applied by the respective head immediately after application thereof.

30. The apparatus according to claim 27, wherein said apparatus includes:
a plurality of drums, each adapted to carry a plurality of bottles on its outer surface; and
an intermittently-operated drive for intermittently rotating all said drums together.
